(19) United States
(12) Patent Application Publication
(10) Pub. No.: US 2006/0136556 A1
(43) Pub. Date: Jun. 22, 2006

(54) Systems and methods for personalizing audio data

(75) Inventors: Lane E. Stevens, Alpine, UT (US); Mark Baker, Encino, CA (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: Eclips, LLC

(21) Appl. No.: 11/287,851

(22) Filed: Nov. 28, 2005

Related U.S. Application Data
(60) Provisional application No. 60/637,286, filed on Dec. 17, 2004.

(51) Int. Cl. G06F 15/16

(52) U.S. Cl. 709/203

(57) ABSTRACT

Systems and methods for customizing data including audio data. A database stores audio data, customization data, and metadata that is related to both the audio data and the customization data. A user can select audio from the audio data. Then, information is collected from the user based on the selected audio and the metadata associated with the selected audio. From the collected information, inserts are identified from the customization data. The inserts are merged into the selected audio to produce customized audio. The inserts are seamlessly integrated into the selected audio to eliminate aural discontinuities and improve the listening experience. The inserts and the audio data are pre-processed to insure that merging the inserts into the audio data provides customized audio that is seamlessly integrated. The customized audio can then be delivered to the recipient.

### CROSS-REFERENCE TO RELATED APPLICATIONS

This application claims the benefit of U.S. Provisional Patent Application Ser. No. 60/637,286, filed Dec. 17, 2004, which is hereby incorporated by reference.

### BACKGROUND OF THE INVENTION

1. The Field of the Invention

The present invention relates to systems and methods for personalizing data. More particularly, embodiments of the invention relate to systems and methods for delivering personalized audio data over a network.

2. The Relevant Technology

Audio data can be saved in a wide variety of different formats and is often included as part of the multimedia Internet experience. Conventional websites generate and use audio data in many different ways. However, any audio data presented or delivered as part of a web site has already been prepared and cannot be customized. For example, a user can select and listen to a song over the Internet or to a preview of a song. However, the selected song cannot be customized using conventional systems. A user cannot hear customized lyrics in a song that does not already include the customized lyrics. Attempts to customize the song typically result in audio that is stilted and disjointed.

Automated telephone systems are an example of a system that attempts to automate the interaction with the user. These types of systems use a mapping system and/or voice recognition to identify audio files for playback. For example, this type of communication occurs when a user is calling a bank to check account balances or perform other automated functions. The automated system of the bank enables users to use their touchpad to provide identifying information or relies on voice recognition. The information collected from the user is then used to identify the audio data that is communicated to the user. The audio delivered to the user, however, is awkward in the sense that the audio is not seamlessly integrated. In other words, the audio sounds disjointed and is not seamless. The audio sounds as if it is simply a concatenation of different audio files and the user can easily distinguish where one file ends and the next begins.

In other words, conventional systems do not generate audio data that seamlessly integrates multiple audio files in a manner that makes the audio data sound like an original recording rather than a computer generated message. Further, conventional systems do not typically personalize the content of the audio data based on user information or on context information associated with the user.

### BRIEF SUMMARY OF THE INVENTION

These and other limitations are overcome by embodiments of the invention, which relate to systems and methods for customizing or personalizing audio data. In one example, a method for customizing audio data includes collecting a song type from a user to identify a base track from a database of audio data. Next, the method collects information from the user through menus. The menus presented to the user are typically based on metadata associated with the song type collected from the user. The collected information from the user is used to identify inserts from a database of customization data. Then, the customized audio is generated by merging the inserts into the base track. The inserts are seamlessly integrated into the base track such that the base track appears as if it were an original recording.

In another embodiment, audio data (or other type of digital content) is customized by first selecting a song type and customization data. The song type is often associated with a base track and the customization data is associated with inserts that have been prepared for insertion into the base track. Once the inserts and the base track are identified or selected, the inserts are merged into the base track to produce the customized audio. The customized audio can then be previewed by the user. After previewing the customized audio, the customized audio (e.g., song, clip, etc.) is delivered to the recipient, for example, via email with a link to the customized audio. Alternatively, the user can finalize additional data such as the spelling of the recipient's name, the text of the lyrics, and the like before delivering the customized audio to the recipient. In addition to the customized audio, the recipient may also be presented with customized graphics (such as a flash animation, by way of example) that can accompany the customized audio.

These and other advantages and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates an example of a storage system for storing audio data, customization data, and metadata that is related to the audio data and the customization data,

FIG. 2 illustrates a prepared base track of audio data that includes insertion points and an insert that can be merged into the base track of audio data;

FIG. 3 illustrates an exemplary and scalable system for delivering customized audio data;

FIG. 4 illustrates one embodiment of a method for delivering audio data;

FIG. 5 illustrates an embodiment of a method for generating customized audio data;

FIG. 6 illustrates the process for generating and dispatching personalized media clips in accordance with one or more embodiments of the invention;

FIG. 7 illustrates the elements of the system for generating and dispatching personalized media clips in accordance with one or more embodiments of the invention;

FIG. 8 illustrates the process for producing personalized media clips in accordance with one or more embodiments of the invention;

FIG. 9A is a block diagram representing the elements of one or more media clips configured in accordance with one or more embodiments of the invention;

FIG. 9B illustrates a base track in multiple segments and the process of concatenating segments to generate customized audio; and

FIG. 10 illustrates the process for dispatching personalized media clips in accordance with one or more embodiments of the invention.

### DETAILED DESCRIPTION OF THE PREFERRED EMBODIMENTS

Embodiments of the invention relate to systems and methods for delivering audio data including, by way of example and not limitation, music, songs, media clips or audio clips and other types of audio data. Embodiments of the invention deliver customized audio data to requesting users or to others. The customized audio data is typically generated when it is requested and the customized portion of the audio data is seamlessly integrated into the audio data.

Embodiments of the invention relate to a method and apparatus for generating and dispatching personalized media clips. In the following description, numerous specific details are set forth to provide a more thorough description of embodiments of the invention. It will be apparent, however, to one skilled in the art, that the invention may be practiced without these specific details. In other instances, well known features have not been described in detail so as not to obscure the invention.

Users can access a database of audio data over a network (such as the Internet) and provide information that is used to customize a particular song or other audio data. With the customization information received from a user, the song is generated and delivered to the recipient (which may be the user or other person) in a variety of manners and in a variety of different formats.

Embodiments of the invention create a library of audio data that includes base tracks and inserts. The base audio tracks are prepared such that they include insertion points where customized data is inserted. The base tracks and the inserts have been prepared such that when the insert is merged into a base track, the insert is integrated into the track and can be played without noticeable distortion, spiking, or discontinuities. The inserts are typically volume leveled and processed such that the beginning and ending points of the insert match the beginning and ending points of the insertion point of the base track.

The library of base tracks and inserts are coordinated, using information provided by a user, such that the appropriate inserts can be selected and merged with the base track to generate customized audio. Thus, certain embodiments of the invention result in specific instances of customized or personalized audio. After the customized audio is generated, the customized audio is then made available to the identified recipient. The customized audio can be emailed to the recipient or the recipient can access the customized audio over the Internet such that the customized audio plays through the recipient's computer or other electronic device such as a personal audio player.

A library of base tracks and a library of inserts enables embodiments of the invention to derive specific instances of customized audio. By merging selected inserts into the base tracks, customized audio is generated. After customized audio is generated, it may be possible to save the customized audio for future uses. For example, it may be possible to re-customize the audio by swapping certain inserts for other inserts.

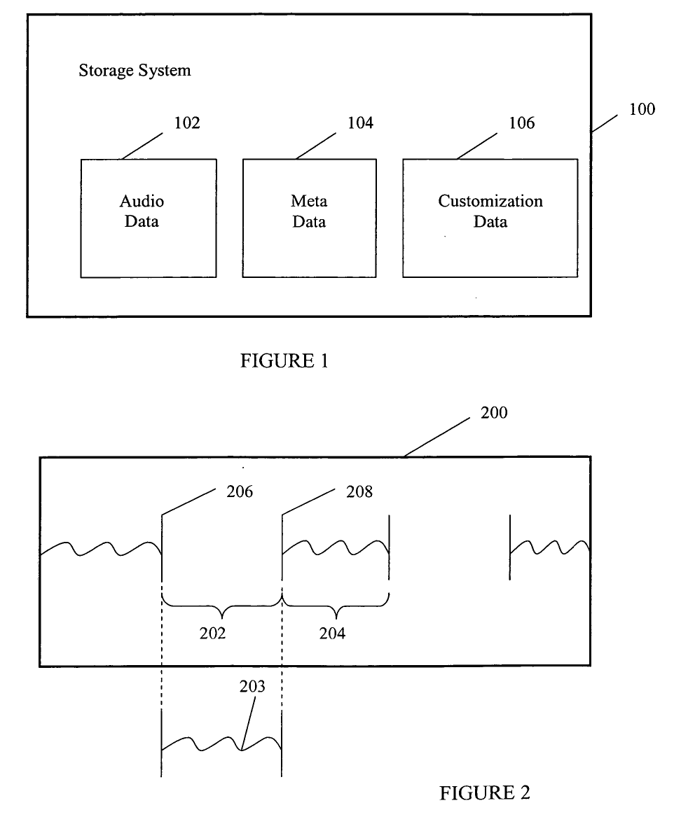

FIG. 1 illustrates an example of a storage system that stores the audio data that can be customized. The storage system can be implemented using various configurations. The storage system 100 may be distributed and include multiple physical storage devices. The storage system 100 stores audio data 102, metadata 104 and customization data 106. The audio data 102 includes the base tracks of audio data such as songs or song clips that can be customized by users. The metadata 104 includes information that is used to help customize the audio data 102. The customization data 106 represents the inserts that are merged into the base tracks when the customized song is generated.

The metadata 104 can be used to identify and describe how the audio data 102 can be customized. The metadata 104 can describe how the customization data 106 is described in menus presented to users, describe the lyrical representation of the customization data 106, describe whether the customization data 106 should be possessive, and the like. The metadata 104 can also describe the base tracks in the audio data 102, such as song type or category.

The metadata describe characteristics of the base track such as the location of the base track in storage, the name of the base track, category, type of singer or narrator (male or female, for example) and associated lyrics. The metadata also associate insertion categories to the base track. Examples of insertion categories include name of the recipient, location (city, state, or country) of the sender or the recipient, color of the recipient's eyes, or other types of customizable inserts. The metadata includes additional data that describe each of the audio samples that can be used as an insert including the location of the sample in storage, the type of the sample (for example, into which insert category or categories the sample fits), textual representation of the data in various contexts (for example how it appears when presented as a selection in a menu, when inserted into the lyrics, as well as inflected forms such as possessive and plural variations), the base tracks with which the sample can be used, and whether or not the sample is active or not (for example, inactive samples would not show up in menus). Also captured are hints that can appear in menus to provide additional context regarding a specific sample. Examples of hints may include whether the vocalist is male or female, and a guide to pronunciation in the case where a proper name may have varied pronunciations or an unusual pronunciation or spelling. Additional metadata are used to associate samples into menus, and includes information regarding the prompt, default values, etc. Finally, the metadata are used to relate variations of the same sample together. For example, in some songs, the name of the recipient may be sung differently, or in a different pitch depending on what part of the song contains the sample, and there may be multiple variants of the same name in a single song. When the user of the system is customizing the song, it is not necessary for them to choose all variations of a name or other insert that are required for the song, but by selecting the menu choice that represents the correct insert concept, all samples in the set are implied.

The customization data 106 represents the data that is merged into the audio data 102. In other words, the customization data 106 includes inserts that can be selected and merged into the base tracks.

For instance, FIG. 2 illustrates an example of audio data (also referred to as a base track) included in the audio data 102 that has been prepared to include insertion points. The audio 200 represents, in this example, a song that has been prepared for customization. The audio 200 includes one or more insertion points represented by the insertion point 202. The portion 204 of the audio 200 is representative of audio that is not customized.

In one embodiment, the audio 200 is prepared in a format such that the inserts included in the customization data 106 can be seamlessly inserted into the audio 200. The audio can be processed in a WAV or PCM format, for example. In fact, the audio data is usually prepared for inserts from the customization data in an uncompressed state.

For each song or audio included in the audio data 102, various information is known about the insertion points. For example, the length (in time units or audio frames) of the insertion point 202 is known, and the position of the insertion point 202 in the audio 200 is also known. In one embodiment, the length of an insert in the customization data exactly matches the length the insert portion 202. Alternatively, the length of the insert can be altered to match the length of the insert portion 202.

Also, the beginning point 206 and the ending point 208 of the insertion point 202 may be modified along with the beginning point and ending point of the insert to ensure that the user experiences a seamless aural transition. The insert or the base track can be volume leveled as well as altered to accommodate the other. This eliminates or substantially reduces spikes or other undesirable aural effects that can have a detrimental effect on the listening experience. Further, it enables multiple inserts to be seamlessly integrated with the audio 200 without having to reprocess the audio 200 to accommodate other inserts.

The generation of the inserts in the customization data 106 is performed before the customized audio is prepared. The inserts are recorded and then processed such that they can be integrated or merged into the insertion points of the base audio tracks included in the audio data 102. The library of inserts can be quickly accessed as needed for any particular customization of the audio data. In addition, the metadata 104 needed to correlate the audio data 102 and the customization data 106 can also be created before a customized song is actually generated and delivered.

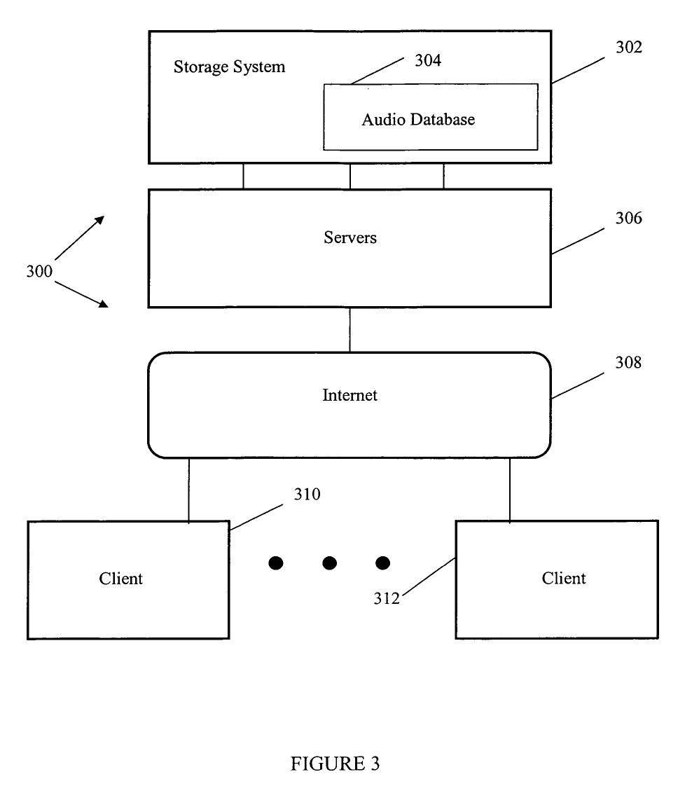

FIG. 3 illustrates an exemplary environment for implementing embodiments of the invention. The storage system 302 includes an audio database 304 that includes, as described above, audio data, metadata, and customization data. Clients, represented by the clients 310 and 312, can access the servers 306 over a network 308, such as the Internet, to create customized audio that can then be delivered to a recipient. The servers 306 can be expanded such that the ability to deliver customized audio is scalable.

In addition, other optimizations can be performed to further streamline the ability of the servers to deliver customized audio. For example, once a song has been generated in the sense that inserts have been blended into a base track, a copy of the resulting audio data can be saved. When that song is requested at a later date, only the inserts that have changed need to be replaced with new inserts from the customization data. For example, a copy of an audio song or clip with four inserts is saved. When another request for the same audio song is received and three of the inserts are the same, then only one insert needs to be merged when the song is generated. An insert can simply be replaced with the new insert.

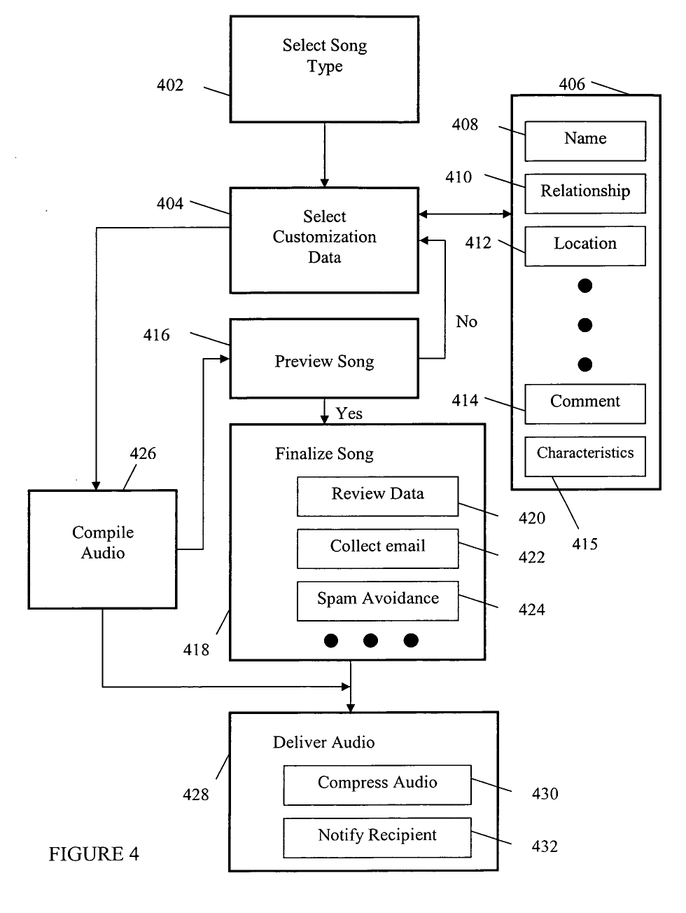

FIG. 4 illustrates an example of generating or delivering customized audio. FIG. 4 illustrates the generation of a customized song, but one of skill in the art can appreciate the ability to customize other types of audio. The process begins when a user accesses a website hosted by the servers illustrated in FIG. 3. One of skill in the art can appreciate that the steps or acts described herein are accomplished using one or more web pages. Typically, a user is asked to select audio data by selecting a song type 402. Selecting a song type can be based on various categories of song (humorous song, holiday song, romantic song, etc.). In some instances, a user can select a particular song by providing the title of the song. After the song type is selected, the servers can identify the inserts that are needed as well as what type of information needs to be collected to select the appropriate inserts from the customization data.

Thus, the user is prompted to provide or select customization data 404 after the song type is selected. The selection of specific inserts from the customization data is typically menu driven and depends on the song type previously selected. For example, one of the inserts commonly required for a base song is the name of the recipient. The servers therefore present a menu to the user from which the recipient's name is selected. If the name of the recipient is not on the list, then the user may be presented with hints to help find the name if the spelling is different or unknown. Alternatively the user may select a phonetic equivalent, use a pet name, insert silence into the song, and the like. The actual spelling of the name or other customization data can be corrected at a later time in one embodiment. This enables the text of the customized audio to be presented in a pleasing manner as well.

Typically, a user is limited to choices that are in the menus as the customization data typically contains inserts associated with selections in the menus. If the recipient is male, the sex of the singer of the audio can be selected by the user or by default. Typically, a female singer is selected for a male recipient and vice versa.

Box 406 illustrates examples of information that is collected from a user using menus on a web page. Using the information collected in this manner, the appropriate inserts can be selected and ultimately merged into the base track of the selected song type. Examples of information that may be collected from a user include the name 408 of the recipient, the relationship 410 of the recipient with respect to the user, the location 412 of the recipient, a comment 414 selected by the user, and various characteristics 415 (eye color, hair color, etc.) of the recipient, and the like or any combination thereof. The menus presented to the user can be dependent on the metadata associated with the selected song type. For example, if the selected song type only has an insert for the name of the recipient, then only the name of the recipient is collected during the selection of the customization data 404.

After the customization data is selected 404, the audio can be compiled 426 and delivered 428 to the recipient. In this case, the selected song and the inserts are merged together or concatenated. As discussed herein, the base song and the inserts are typically prepared beforehand such that when concatenated, the customized audio provides seamless transitions at the points where concatenation occurs in the customized song.

In some instances, the user may want to preview the customized audio before it is delivered to the recipient. In this case, the customized song is previewed 416 after it is compiled 426. As illustrated in FIG. 4, the customized audio is compiled 426, for example, by merging the base track and the inserts from the customization data. The customized song is then played for the user over the network. Also, a copy of the lyrics including the inserts may be presented to the user for review.

If the preview of the customized song is not acceptable or if a mistake is made, the user returns to the selection of customization data 404 for corrections and the song is then compiled 426 and previewed 416 again for the user. If the preview of the customized song is acceptable, the customized song is then finalized 418. At this point, the user can review the data 420 and make corrections as needed. For example, the user may provide a particular spelling of the name that is included in the lyrics. At this point, the customized song has already been approved by the user. Of course, the web page may provide a way for the user to restart the process at any time or to again listen to the preview of the customized song.

During finalization, the user's email address and the recipients email address are typically collected. The user's email address is collected as an attempt at spam avoidance 424. Using the user's email address may help prevent the email sent to the recipient from being filtered as spam. The user typically pays for the customized song at this point.

Next, the customized song or audio is delivered. Because the song is typically generated by merging the uncompressed inserts into the uncompressed base track, delivering the audio 428 often includes compressing the generated audio 430. For example, an MP3 of the customized audio may be created and be accessible to a user via download or email, for example. The recipient is also notified 432, typically using email. The notification email may include a link to a website where the recipient can access and listen to the customized audio.

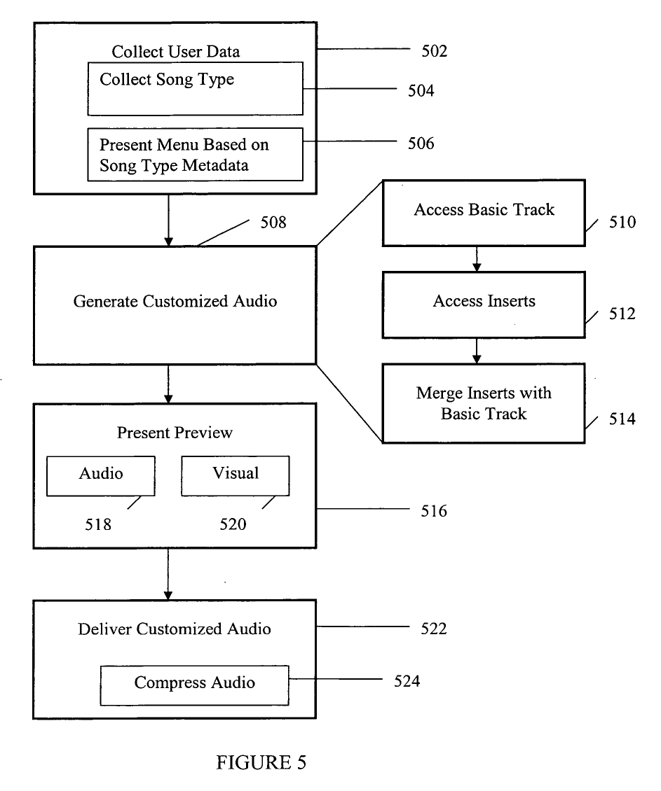

FIG. 5 illustrates an exemplary method for generating customized data from the perspective of the server computers that are accessed by a user. The server computer(s) first collect user data 502. The user data is used to begin the process of customizing audio data that is already stored at the server's storage system. Thus, the server, through one or more web pages, prompts the user to input the customization data. This can include collecting a song type 504 and then presenting one or more menus based on metadata 506 associated with the collected song type. One of skill in the art can appreciate that the collection of data can be performed using other techniques in addition to menus.

After the data is collected, the customized audio is generated 508. Generating the customized audio can include accessing the base track 510 from the audio database, accessing the inserts 512 that are identified using the information collected from the user, and then merging the inserts into the base track. The result of merging the inserts into the base track is customized audio. The inserts and the base tracks were previously processed such that the inserts seamlessly integrate with the base track and do not result in discontinuities in the customized track. As previously stated, discontinuities can be easily identified aurally and detract from the listening experience.

After the customized audio is prepared, a preview of the customized audio is presented to the user 518. This includes, in one embodiment, both an audio 518 rendition of the customized audio and a visual 520 representation of certain information. The visual representation may include the lyrics of the customized audio. The lyrics include the collected data in one example.

At this point, the user may have the option of correcting certain spellings, etc., without having an impact on the audio itself. If the lyrics are also delivered to the recipient, this ensures that the recipient's name, for example, is spelled correctly. For example, the name “Kaitlin” may be selected from the menu when the user selects the recipients name. The recipient may actually spell her name “Katelyn”. Thus, the insert is the same for both spellings, but the visual representation of the lyrics can be adapted or altered for these types of circumstances.

After all changes are made and the preview of the customized audio is accepted, the customized audio can be delivered. This can occur by sending an email to the recipient that includes a link to the customized audio. Upon selecting the link, the recipient can access and listen to the customized audio. Typically, the customized audio is compressed 524 into a smaller format. For example, the customized audio is compressed from WAV or PCM format to the MP3 format. When the recipient accesses the customized audio, the lyrics and other graphics may be displayed using any suitable technology such as HTML or FLASH technologies. In another embodiment, a compressed version can be downloaded to a device or to a computer of the recipient. The user may also desire to download a copy of the customized song.

Although embodiments of the invention have been described in terms of audio data, embodiments of the invention can also be applied to other types of activities. For example, a toy manufacturer can use embodiments of the invention to customize toys. For example, an action figure or doll can be customized to know and speak the name of the child that will use the toy, or to speak other information specific to the child or specific to a stage in the development of the child such as learning to read, or learning some other new skill. Embodiments of the invention can be used for personalized advertising. For example, invitations or advertising monologues can be customized as appropriate to the target audience or individual. In one example, a movie star invites the listener, calling him by name, to go see his latest action movie.

Embodiments of the invention can further be adapted to other applications and delivery methods. For example, cellular telephones have the ability to play sounds that are associated with specific callers. These cellular telephones also have the ability to accept, for example, MP3 clips or other formats of audio data. In fact, the ring tones currently available to users of cellular devices are examples of audio that can be received and played by cellular telephones.

In one embodiment of the invention, a user can customize a ring tone as described herein and send it to a cellular device. As a result, the customized ring tone can then be assigned as a generic ring tone or set as the specific ring tone for a particular caller.

Embodiments of the invention can also be adapted to the sounds that a user of a cellular telephone hears while calling a particular number, also referred to as a ringback tone. This audio can be customized and delivered to the cellular telephone as described herein.

In another embodiment of the invention, the customized audio can be used in advertising. For example, a sponsoring organization can display advertising as the customized audio is being generated. As discussed above, several steps or acts are performed during the customization process, and advertising can be displayed during this process. Further, as a user goes from one web page to the next web page, the advertising can be updated or changed.

When the customized audio is delivered to the recipient, additional advertising can be presented in the visual aspect associated with the song. For example, the words of the song may be displayed to the recipient as discussed herein. At the same time, advertising may also be included in the portion that is visible to the recipient rather than aural. In addition, the audio can be further customized to include a message from the sponsor. The message may be related to certain lyrics in the song, product placement aspects, and the like. The advertising base is expanded as the customized audio is propagated by the various recipients.

When the customized audio (such as a multimedia clip) is a song, it is often necessary to ensure that the inserts keep the meter of the song to as to appear as if it were an original recording. In other examples, such as those described above (advertising monologues, etc.), a situation may occur where there is no need to use a base track. In this case, a series of inserts can be concatenated together to provide the resulting customized audio. The inserts can still be processed however to ensure that there is no discontinuity between inserts in this type of customized audio or clip.

The invention has many different applications and implementations. One or more embodiments of the invention, however, are directed to a software program and/or computer hardware configured to enable users to select one or more master clips or base tracks having predefined gaps, obtain insert data (e.g., an insert clip), seamlessly merge the insert data into the selected master clip to generate a media clip, and distribute the media clip having the insert data to one or more receiving users for playback.

An insert clip may contain any type of data. In most instances, however, the insert clip is utilized for purposes of adding variables such as a name, place, time, gender, product name or any other desirable information to a master clip. The integration between the master clip and the insert clip is seamless. Regardless of the size of the insert clip the finished media clip lacks any easily noticeable gaps or intonation changes. Even through the media clips are generated using a plurality of different clips, the media clips sounds as if it was originally recorded as it is heard. Flash animation or other types of multimedia data can be added to the media clip to enhance the user experience during playback.

Although the content of the master clip and/or the insert clip may use any voice, on many occasions celebrity voices or the voices of celebrity impersonators are utilized. The master clip, for instance, might be recorded by the celebrity and the insert clip recorded using a voice over artist. Thus, embodiments of the invention provide a mechanism for generating and distributing personalized media clips using what sounds like and/or is the voice of a celebrity. For instance, once the system merges one or more master clips together with one or more insert clips and thereby generates the media clip, the system can provide the media clip to a device and/or program for playback.

Playback of the media clip initiates at a number of different types of devices and can be triggered by a multitude of different events. Some examples of the types of playback devices used in accordance with one or more embodiments of the invention, include (but are not limited to) a computational device configured to access a network (e.g., the World Wide Web (WWW)) via a browser, an e-mail client, or some other network interface. A cell phone or any other type of portable or non-portable device (satellite, mp3 player, digital cable, and/or satellite radio) configured to output media clips (e.g., audio, video, etc.) may also function as a playback device.

The time at which playback occurs depends, in at least one embodiment of the invention, upon the context of the device. Displaying a certain website, reading a particular e-mail, calling a particular person, or being in a certain location are some of the examples of the different contexts that might trigger playback. For instance, a user of the system might initiate playback by visiting a certain web page (or some other type of online document or program) where the user will hear a personalized greeting from a celebrity. If, for example, the user visits an online bookstore, that user might receive a personal greeting from one of the user's favorite authors who then proceeds to promote his newest novel. Other examples include personalized messages via e-mail, a cell phone, or some other playback device.

If the media clip is distributed via the WWW, the media clip may be generated and automatically transmitted when the user visits a particular web page. The invention contemplates the use of a variety of different techniques for dynamically generating media clips. In one implementation the system obtains user information from a cookie file to instantaneously render a personalized multimedia file. In other instances user data is already known by the system or obtained and confirmed via a log-in process.

One or more embodiments of the invention are designed to generate and distribute multimedia clips on low cost server farms of arbitrary size. The server farm can be configured to provide the full range of necessary application services, and each of the services can be deployed across one or more servers based on the scalability requirements that apply to the service.

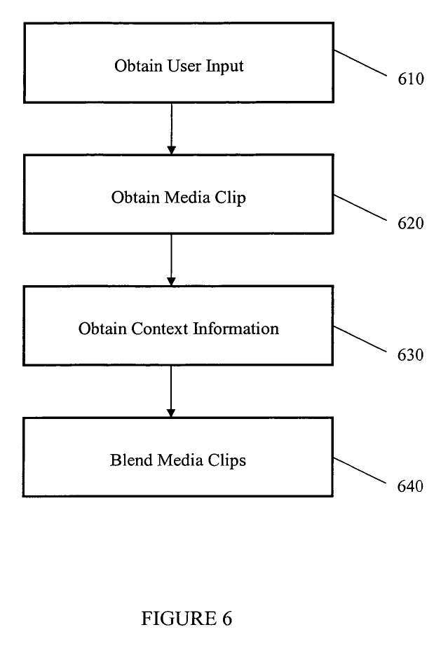

FIG. 6 shows an example of the process for generating and dispatching context dependent media clips in accordance with an embodiment of the invention. At step 610, the system embodying one or more aspects of the invention obtains user information along with a request for a document or data stream having an associated media clip. Such user information is typically obtained via the user interface (e.g., a web browser) that initiated the request. However, in other embodiments of the invention, the user information is obtained separately from the request for data. For instance, the request may come when the user opts-in to receiving media clips generated using the technique described herein and the user information may be obtained during that opt-in process. The media clip, however, may be delivered for playback anytime subsequent to the opt-in or to a registration process.

Although, the invention contemplates the, use of many different interfaces (e.g., a web interface, e-mail client, and/or any other type of device configured to execute playback of the media clip) there are some specific details and generalities associated with the use of each type of interface. For instance, the web interface and/or e-mail interface provides users with a way to access, through an interconnection fabric such as a computer network, one or more server sites. To this end the client and server system supports any type of network communication, including, but not limited to wireless networks, networking through telecommunication systems such as the phone system, optical networks and any other data transport mechanism that enables a client system to communicate with a server system. The user interface also supports data streaming, as in the case of streaming multimedia data to a browser plug-in, a multimedia player, and/or any type of hardware device capable of playing multimedia data.

In accordance with one or more embodiments of the invention, the user interface provides a mechanism for obtaining a unique identifier about each user that accesses the system. Any data item that uniquely identifies a user or device is referred to as a unique identifier. For instance a serial number and/or a user name and password can act as a unique identifier and thereby provide access to the system while restricting unauthorized access. In at least one implementation of the invention the unique identifier is a cookie file containing user information (e.g., user name, age, and any other information about the user) or a pointer to the appropriate user information. Once the system obtains the cookie information, that information is used for purposes of rendering a personalized multimedia file. For instance, the system can utilize the information contained within the cookie file to determine which insert clip to associate with a master clip for purposes of rendering the media clip. In other examples, the system may use a third party authentication services (e.g., Microsoft's Passport™) to authorize access to the system. By identifying users, embodiments of the invention are configured to selectively determine the content of the multimedia data based on user information such as a user type and user preferences.

At step 620, the system obtains one or more clips (e.g. master clip and/or insert clip(s) that are to be merged together in order to generate the appropriate media clip. The system may obtain the master clips, insert clips, and/or other multimedia clips from a variety of locations. Such locations include database storage systems, data files, network locations, hard drives, optical storage devices and any medium capable of storing data. In an embodiment of the invention, the storage location is a relational database system. A database system may hold the master clips and/or insert clips used to generate the media clips and/or a variety of other data associated with each media clip. The data associated with the media clip allows for categorizing, classifying and searching media clips based on attributes. Such database systems may be configured to index data in the database for purposes of expediting the process of searching for specific information in the database. The database may have multiple mirrors to enable the system to scale up so it can handle an ever-growing number of users.

At step 630, embodiments of the invention optionally obtain context information from any number of sources. For example, multimedia attributes may be obtained from a database system, time from a clock system, events information from a calendaring system, geographical information from a global positioning system and any other system capable of providing context information to embodiments of the invention. Context information may combine attribute information and rule information to determine a means and time for initiating playback. For example, an event originating from a calendaring system may specify which delivery means to use for delivering output media clip depending on time of the day, type of the event, events preceding (or succeeding) the event, or location of the user. If the user is online, playback may be via the web interface, if the user is using e-mail, playback may be in the form of an e-mail, if the user is not doing either activities playback may be via a cellular phone. The system may use other context attributes to determine exclusion rules between media clips. For example, insert media clips designed for use in certain context such as happy occasions, may only be used in some context categories and not others. By using intelligent tools to interpret context rules, embodiments of the invention allow for providing an engine that may automatically handle tasks on behalf of persons.

At step 640, the system generates the media clip using user input and optionally the context information to select the appropriate set of one or more master clips and/or a set of one or more insert clips to merge together for playback. The system may utilize context information (e.g., user preferences) to determine the types of media clips to be used, the type of processing which embodiments of the invention are to perform, and/or the type of mechanism to be utilized for delivery and/or playback. Embodiments of the invention may carry out any type of audio and video processing. For example, the system can mix insert clips with the master clip, by replacing portions of the master clip or interleaving over blank portions of the master clip (also referred to herein as a base track).

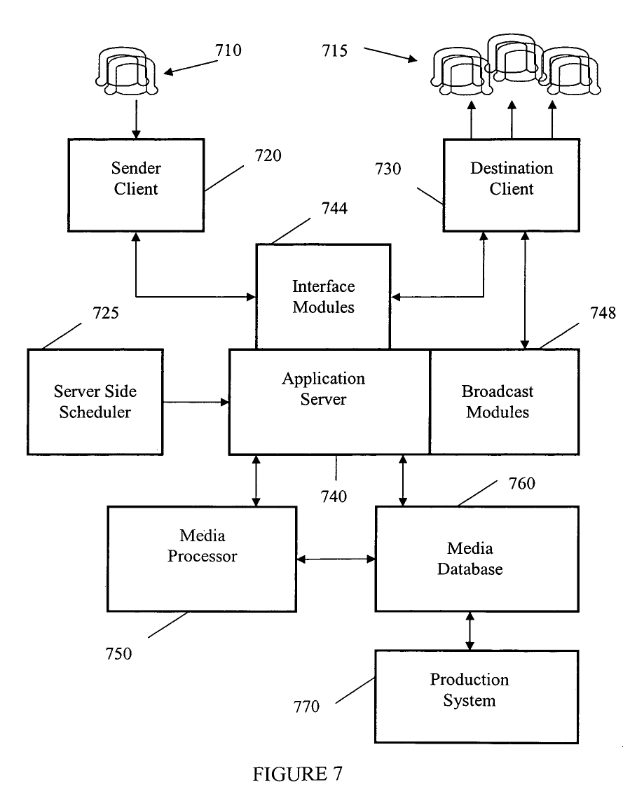

FIG. 7 is a block diagram illustrating the various components of a system configured to generate and dispatch media clips. Embodiments of the invention provide user 710 with a way to generate and distribute media clips to one or more other recipients 715. The reader should note that the term user and/or recipient as contained herein refers to a person using an embodiment of the invention and/or to processes such as computer applications that are programmed to run at specific times and execute programmed tasks. Typically, user 710 utilizes a sender client 720. A sender client 720 is typically a computing device capable of communicating through a network with one or more types of networks. The computing device may be a computer equipped with at least one processor, memory and storage media. The computing device is equipped and configured to communicate using at least one network communication means. For example, a client may be equipped with a modem to communicate through (wire based or wave based wireless) telephone services. The computing device is configured to communicate through one or more networking protocols (e.g., Transmission Control Protocol (TCP) in combination with the Internet Protocol (IP)) to support access and communication between devices though a network such as the Internet.

Computing devices include cellular telephones, Personal Digital Assistants (PDA), desktop computers, laptop computers and any electronic apparatus capable of communicating though a wire-based and/or wireless network. A computing device typically runs applications capable of supporting one or more networking protocols, and processing and interpreting network data. For example, a client may be a personal digital assistant equipped with a browser capable of rendering Hypertext Markup Language (HTML), a JAVA virtual machine capable of running applets received from a remote server, and any other computer program code that supports communication between the user and a remote machine. Other applications allow the user to upload personal media clips, comprising e-mail client, data streaming service supported by the client, an HyperText Transport Protocol (HTTP) posting and any other means that allows a user to post media clips to a server.

Destination client 730 (also referred as delivery recipient and delivery clients) are also computing devices with the distinctive feature that they provide a multimedia player or they allow access to a location that supports multimedia playing. For example, a destination client may be a telephone set that allows one or more users to access a broadcast module 748 to remotely play media clips. Other types of multimedia destination clients may comprise a desktop computer equipped with a multimedia player, a personal digital assistant and any other electronic device capable of playing a media clip or allowing access to a network location that delivers media clips (e.g., Multimedia streaming server).

Application server 740 is designed to handle access to and the processing of media clips and typically comprises one or more user interface modules 744 capable of handling communication to users (and/or optionally receivers) for purposes of obtaining user input. Both the sender client 720 and the destination client 730 have access to the application server 740 through the interface modules 744. By way of example, the application server 740 drives the behavior of the application for customizing content. The application server 740 determines what the customization requirements are for a given product based on the user input, coordinates with various other modules and components as shown in FIG. 7 to present the correct data in the correct format. Interface modules 744 may provide, for example, common gateway interface program for generating web pages, and receiving and interpreting user input. For example, the interface modules allow users to authenticate with a website, and retrieve user preferences to generate customized web pages to the user. Customized web pages may also be based on other user's preferences. For example, if a user is part of a team following one or more definitions, the user may have access to information in the databases based not only on the user preferences, but also on permissions defined by other users. Other context information may be retrieved from a plurality of sources such as calendaring systems, location information systems and any other system that can interface with embodiments of the invention.

The application server 740 is capable of connecting to third party servers (e.g., other websites), local or remote databases to collect context and/or media clips information. User input may be provided by a scheduler 725. The scheduler 725 may be on the server side, such as shown on FIG. 7, and/or on the client side, such as in an input client 720. The scheduler 725 provides a mechanism for choosing context information or types of context information and media clips, and utilize the user input to automatically schedule tasks (e.g., playback) for execution on systems embodying aspects of the invention. The scheduler 725 is one or more computer programs running on one or more client and/or server machines. For example, a scheduler 725 may have a calendaring system running on a client machine that communicates with one or more calendaring systems running on one or more client or server systems designed to work in collaboration to determine the context of events. In the latter example, a first user may program a first scheduler to communicate with schedulers and conditionally determine (e.g., depending on information obtained from other systems) how to generate an input that is provided to embodiments of the invention.

Systems embodying the invention may utilize multimedia generation engine 750 to process media clips. For example, after the application server 740 determines the context, and the master and insert clips to use for generating the output media clips, application server 740 communicates that information to multimedia generation engine 750 so the multimedia generation engine 750 can retrieve the data for the media clips from the database 760, and uses the input information to generate one or more media clips. Multimedia media clips generation involves applying one or more processing algorithms to the input data. Typical processing involves merging/mixing, audio dubbing, inserting media clips and any other type of processing that takes one or more media clips and generating one or more new media clips based on context information.

Examples of the database 760 include any type of commercially available relational database system. The database 760 can include or store audio data, meta data, customization data such as described herein that is used to customize content such as audio content. The database 760 may also be any file system accessible locally or through a network.

Systems embodying the invention may have a multimedia production system 770. The production system 770 may include the tools and processes needed to accumulate the audio data and corresponding metadata that is stored in the media database 760. Typically a multimedia production system allows a user to utilize newly recorded media clips, or existing media clips to edit the media clips and prepare the media clips for usage with embodiments of the invention. The production phase is disclosed below in further detail, and involves producing media clips properties, attributes and symbols to allow, at a later stage, the multimedia generation engine to combine 2 or more media clips to generate an output media clips. A production system 770 allows a producer to create clips using real life recording or computer generated media that include audio, video or any other electronic data format. The production system allows users to generate master clips while saving insertion points and attributes that associate the master clip with context information, and relationships between media clips.

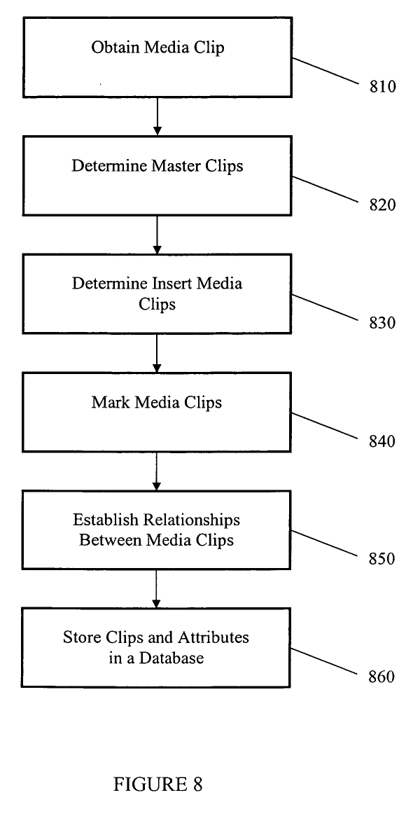

FIG. 8 shows illustrates the process for producing media clips in accordance with an embodiment of the invention. At step 810, the system obtains one or more clips and/or other media clips. Step 810 may involve recording a live performance (e.g., a commercial or an artistic performance by a band), or capturing computer synthesized sounds. At step 820, the producer identifies the clips that are to become master clips or base audio tracks and edits the clips to leave gaps for dropping one or more insert clips. For purposes of aiding in the retrieval of a particular clip, the producer may also input attributes to describe the sounds or the images in the media clips. Some examples of data that may serve as attributes are text keywords and key phrases, a sound clip preview, an image preview or any other data format that may characterize a media clip.

At step 830, the producer also determines among all available media clips those that are designed to be insert clips. Insert clips are fashioned in embodiments of the invention to be inserted or mixed at one or more locations in one or more media clips (e.g., master clips). In some instances insert clips are artfully recorded to fill a predetermined duration of time. If a master clip leaves a gap of 3 seconds to place a person's name, the insert clip may be recorded to fill up the entire 3 seconds. Thus, the underlying music track seamlessly integrates the master dip together with the insert clip. An insert clip may itself be a master clip, if the insert clip is designed for mixing with other media clips. The system also provides a mechanism for associating insert clips with keywords, key phrases, sound preview, image preview and any other data format that allow the system to identify, classify, sort or otherwise manipulate the insert clip for purposes of data management.

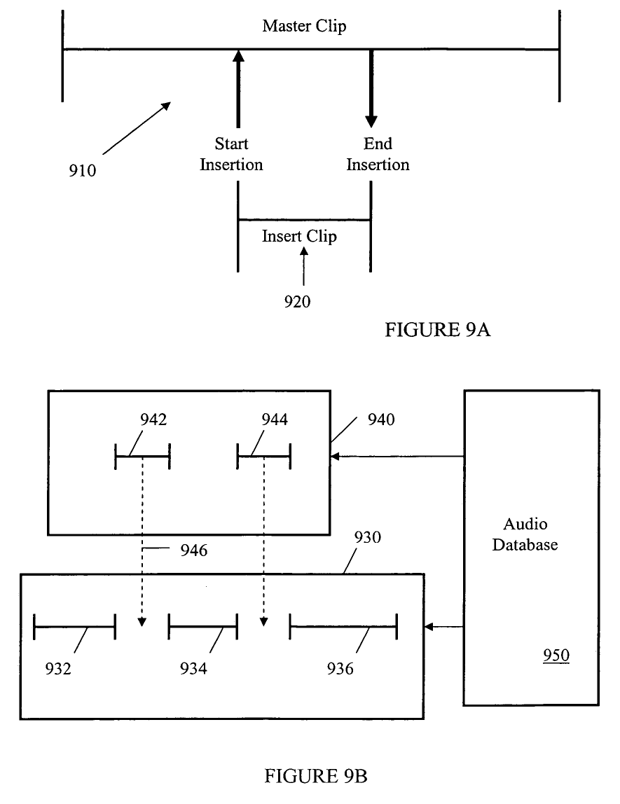

At step 840, the master clip producer marks the clip with insertion points. The invention contemplates the use of various techniques for marking insertion points. The system may, for instance, embed a signal having an identifiable pattern to mark a particular location in a master clip of other type of media clip. The signal is checked for when the system is looking for a location to place an insert clip. Other approaches involve defining location information and storing the location information along with the media clips (e.g., in a database system). Alternatively, the system may utilize a plurality of master clips that each begin and/or end at the point where an insert clip is to be placed. When the master clips are merged together with one or more appropriate insert clips the result is a seamless media clip ready for playback. Using this technique a song or some other type of recorded information is split into a set of sequential files (e.g., WAV, AVI, MP3, etc. . . . ), certain files are identified as insert files, the voice track is removed from the insert files, and an insert clip is recorded over the insert file. In other embodiments of the invention, there is no need to remove the voice track because the insert clips are recorded without such information. Thus, the producer can create the insert clip by simply adding the appropriate voice data to the clip. In either case the master clips and insert clips are then merged together to create a finalized media clip. The system may generate the media clip on the fly by integrating the appropriate master clips and insert clips together, or it may retrieve an already created media clip from the database. The producer of a media clip may define mixing and insertion properties. The system may use such properties to define the way an insert clip is merged together with one or more master clips. For instance, properties may enable the system to know when to fade the master clip signal to allow for seamless integration of an insert clip and slowly return to normal after the insert clip completes. The markings indicating the split and merge locations may be embedded codes, using specific start and end codes (see e.g., FIGS. 9A and 9B), or may be stored separately. The marking codes may also be specific to the type of processing required/allowed to carry out the mixing or insertion of media clips. In embodiments of the invention, the position may be indicated by a text description (e.g., text in an associated file)) and/or by a signal with special characteristics.

At step 860, the multimedia data (e.g., master clips, insert clips, finished media clips, and/or any other accompanying multimedia data) are stored in a suitable location. Some example, of the types of location appropriate for one or more embodiments of the invention include a database system or any other type of data repository. If high availability is desired, the database system can mirror the data across several network nodes. The database system may also contain attributes and properties relating to each of the clips. Such information provides a mechanism for determining which clip is appropriate in a given context.

FIG. 9A illustrates the components of a media clip configured in accordance with an embodiment of the invention. Base track or master clip 910 contains any type of multimedia data including, but not limited to, audio and/or video. For example, the customized audio may serve as a sound track for a video. One or more master clips can be merged together to create a media clip ready for playback. Merging clips together can include, concatenating multiple clips to form a continuous customized media clip. As previously stated, the various clips have been configured such that, when played, there is no aural discontinuity at the locations where concatenation or merging occurs. Insert clip 920 can also contain any type of data (e.g., audio, video, etc. . . . ). The system may combine two or more media clips to form either a master clip or insert clip so long as the clips have at least one property in common in one embodiment. For example, an audio clip may be merged with a video clip if the audio track, included with the video clip has the same characteristics as the audio clip to be inserted. The location where the system interleaves insert clip 920 with one or more master clips 910 is marked by a start and end point. The insert clip is recorded to use the entire duration between the start and end point, thereby allowing the insert clip to sound or appear seamlessly integrated with the master clip.

FIG. 9B further illustrates an exemplary process for generating customized audio by concatenating clips. In this example, the insert clips 940 and the base track 930 are retrieved from the audio database 950. The base track 930 is represented, in this embodiment, as a series of clips 932, 934, and 936. By organizing the base track 930 as a series of related clips 932, 934, and 936, the generation of the customized audio can be achieved by concatenation in one embodiment. The timing between clips in the base track 930 is known and taken into account by the base track 930 and/or the insert clips 940.

As previously indicated, the insert clips 940 are often selected according to input received from a user. After the base track 930 and the insert clips 940 are identified, the customized audio can be generated or compiled. In this example, the insert clip 942 is concatenated with the clip 932 from the base track 930 as illustrated by the arrow 946. Next, the clip 934 is then added to the insert clip 942. In a similar manner, the insert clip 944 and clip 936 are concatenated. The result of the concatenation is a customized audio clip.

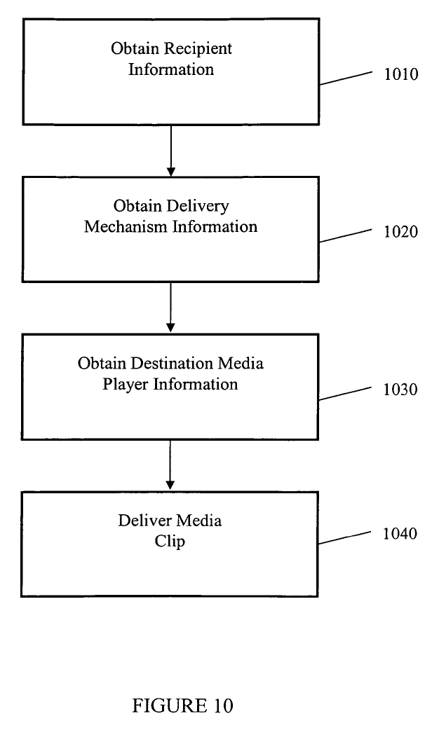

FIG. 10 illustrates the method steps involved in dispatching media clips in accordance with embodiments of the invention. At step 1010, the system obtains information about one or more recipients of the media clip using any number of suitable techniques. For instance, the system may obtain recipient information from a storage location such as a database system, from user input (e.g., via cookies using a web interface), from the recipient's device (e.g., a unique identifier), or from any other medium capable of transferring information about recipients to the system. For example, when a user connects to the system and requests a personalized media clip (e.g., via an earlier opt-in, by belonging a certain group or by a specific request), the system may obtain information about the recipient and/or characteristics about the receiver's multimedia player. In the latter case, the system generates the customized media clip in a format compatible with the multimedia player. In other instances, the system obtains the multimedia player characteristics at the time when the receiver connects to the system. The system then adapts the format of the media clip to match the playback format to one that is compatible with the multimedia player.

At step 1020, the system determines a mechanism for delivery of the media clip assembled using the process described in FIG. 7. The system is configured to deliver customized media clips utilizing one or more different delivery mechanisms. Some examples of the type of delivery mechanisms various embodiments of the invention utilize are telecommunications systems (e.g., the telephone or any other data network), data streaming using a network transport protocol, electronic mail systems, or any other medium capable of transporting electronic or digital data. The system may obtain information about the delivery mechanism from a database system, user input, or using context information sources such as a calendaring or Global Positioning System (GPS). For example, a first user sending a media clip to one or more end-users may specify the delivery mechanism the system may use to reach each receiver. The user may specify the multimedia media clip should be sent as an electronic mail attachment. The user or an internal context information may specify the delivery as a web hyper-link, delivered through electronic mail, for example, the end-users may click through to view the media clip from a data stream. Systems embodying the invention can also deliver content to a telephone voicemail, or directly make a telephone call to one or more recipients and deliver the media clip to persons as an audio message.

At step 1030, the system determines an appropriate format for the media clip. For example, the device to be used for playback may support one or more playback formats. In addition, sometimes different versions of the same multimedia player may support slightly or substantially different data formats. The system is configured to adapt to these inconsistencies by determining what format is desirable for the destination media player and then converting the media clip to that format. The system may obtain the type of data format supported by the multimedia player directly from the device, the user, or it may retrieve such information from a database containing manufacturer information.

At step 1040, the system delivers the personalized media clip to the media player for playback using one or more delivery protocols. For example, the system may deliver media clips through an Internet data stream over Internet protocol or by using any other data delivery medium.

In embodiments of the invention, the resulting personalized or customized audio message is available within a couple of seconds, essentially available in real time. It is often the case that the customized audio can begin to play within a period of time that is not perceived to exceed that of normal internet delays.

Advantageously, embodiments of the invention can generate customized audio in an unattended manner. Manual intervention is not required. In other words, the customization or personalization of the audio is under the control of the user that is customizing the audio.

Embodiments of the invention include a tool to facilitate the creation and purchase of a personalized audio message, and subsequent delivery of the personalized message to the intended recipient without any intervention in the order and delivery process.

Embodiments of the invention also include a tool to deliver sponsored personalized audio messages following the base outline as the process just noted, but sponsored by a third party, and delivery of a sponsorship message to the recipient

Embodiments also relate to methods of “viral” advertising that propagates the advertising message through interest generated in the recipient of a personalized audio message such that they voluntarily wish to continue the propagation of the sponsored message by creating and sending personalized audio messages to others in their network of friends.

Embodiments of the invention, as further described previously, also relate to a meta-data driven approach to the creation of a website for creating Personalized Audio Messages that enables the rapid deployment of a web application that can be used to create and send personalized audio messages.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for customizing audio data, the method comprising:
collecting a song type from a user to identify a base track from a database of audio data;
collecting information from the user through menus, wherein the menus presented to the user are based on metadata associated with the song type collected from the user and wherein the collected information is used to identify one or more inserts from a database of customization data; and
generating customized audio by merging the one or more inserts into the base track.

2. The method of claim 1, wherein collecting information from the user through menus further comprises presenting one or more web pages to the user to collect the information.

3. The method of claim 1, wherein collecting information from the user through menus further comprises presenting the menus based on metadata associated with at least one of the song type or the base track.

4. The method of claim 1, wherein generating customized audio by merging the one or more inserts into the base track further comprises:
accessing the base track; and
identifying insert locations in the base track.

5. The method of claim 1, further comprising preparing the base track and the one or more inserts before collecting a song type from a user.

6. The method of claim 5, wherein preparing the base track and the one or more inserts further comprises one or more of:
marking the base track to identify insert points in the base track;
preparing a particular insert to have a length substantially equal to or less than a length of a particular insertion point; and
preparing a beginning point of the insertion point and an ending point of the insertion point such that each insert merged into the insertion point includes a seamless aural transition at both the beginning point and the ending point.

7. The method of claim 1, further comprising delivering the customized audio to a recipient.

8. The method of claim 7, wherein delivering the customized audio to a recipient further comprises one or more of:
sending an email to the recipient with a link to the customized audio;
compressing the customized audio for download by the recipient; or
presenting additional graphics to the recipient in addition to the customized audio.

9. A method for customizing audio data, the method comprising:
selecting a song type and customization data, wherein the song type is associated with a base track the customization data is associated with one or more inserts;
merging the one or more inserts into the base track to produce a customized audio;
previewing the customized audio;
finalizing additional data associated with the customized audio, the additional data including at least one of lyrics or a name of a recipient of the customized audio; and
delivering the customized audio to the recipient.

10. The method of claim 9, wherein merging the one or more inserts in to the base track to produce a customized audio further comprises inserting the one or more inserts into insertion points of the base track, wherein beginning points and ending points of the insertion points have been prepared to seamlessly integrate with the one or more inserts.

11. The method of claim 9, wherein selecting a song type and customization data further comprises selecting one or more of:
a name of the recipient;
a relationship of the recipient to a user;
a location of the recipient;
characteristics of the recipient;
a comment for the recipient; or
content suited to the recipient.

12. The method of claim 9, wherein finalizing additional data associated with the customized audio, the additional data including at least one of lyrics or a name of a recipient of the customized audio further comprises one or more of:
reviewing the lyrics;
providing an alternative spelling for the name of the recipient in the lyrics; or
collecting an email of one of the user and the recipient such that the customized audio does not appear as spam.

13. The method of claim 9, wherein delivering the customized audio to the recipient further comprises one or more of:
compressing the customized audio;
notifying the recipient of the customized audio by providing a link to the customized audio in an email;
delivering the customized audio to a device of the recipient, wherein the device is a cellular telephone and the customized audio is one a ring tone or a ringback tone;
delivering the customized audio in substantially real-time to the recipient; and
delivering the customized via one of a web interface, email, a file, and over a wireless device.

14. The method of claim 9, further comprising blending the one or more inserts with the base track such that the resulting customized audio appears as an original recording.

15. The method of claim 9, wherein the customized audio comprises one or more of:
a recording included in a personalized toy;
a personalized advertisement;
a ringback tone played to a caller while waiting for a call to be answered;
a first ring tone played on a recipient device, wherein the ring tone is associated with a particular caller;
a voice mail;
a telephone call;
a sponsored advertisement;
a visual advertisement displayed to the recipient as the customized audio is played;
a second ring tone played on the recipient device, wherein the second ring tone is associated with multiple callers; or
a telephone call to the recipient using a voice of a celebrity.

16. The method of claim 9, wherein selecting a song type and customization data further comprises one or more of:
opting in a user such that that song type and customization data are already known; and
identifying the song type and/or the customization data based on a unique identifier associated with the user.

17. A method for dispatching context dependent media clips, the method comprising:
obtaining user information including a request for a media clip;
obtaining a master clip and one or more insert clips based on the request from a user;
receiving context information from one or more sources; and
blending the master clip with the one or more insert clips based on the context information to create the media clip for distribution to a recipient.

18. The method of claim 17, wherein obtaining user information including a request for a media clip further comprises requesting a data stream associated with the media clip.

19. The method of claim 17, wherein receiving context information from one or more sources further comprises one or more of:
obtaining multimedia attributes from a database system;
obtaining a time from a clock system;
obtaining events from a calendaring system;
obtaining geographical information from a global positioning system;
combining attributed and rule data to determine a means and time for initiating playback of the media clip;

20. The method of claim 17, wherein blending the master clip with the one or more insert clips based on the context information to create the media clip for distribution to a recipient further comprises one or more of:
inserting the one or more insert clips over blank portions of the master clip;
replacing portions of the master clip with the one or more insert clips;
ensuring that interfaces between the one or more inserts and the master clip are integrated to minimize distortions in the media clip.

21. The method of claim 17, further comprising correcting additional data associated with the media clip, the additional data including at least lyrics and a name of the recipient.
